(19) United States
(12) Patent Application Publication
(10) Pub. No.: US 2018/0020260 A1
(43) Pub. Date: Jan. 18, 2018

(54) INTERNET MULTIMEDIA SYSTEM BASED ON UNIFORM RESOURCE LOCATOR

(71) Applicant: EverMore Technology Inc., Hsinchu City (TW)

(72) Inventors: Jui-Chi JAO, Hsinchu City (TW); Feng-Liang LEE, Hsinchu City (TW); Chen-Da TSAI, Hsinchu City (TW); Tsung-Jung WANG, Hsinchu City (TW); Feng-Chi YU, Hsinchu City (TW)

(21) Appl. No.: 15/646,866

(22) Filed: Jul. 11, 2017

(30) Foreign Application Priority Data
Jul. 15, 2016 (TW) 105122416

(51) Int. Cl. H04N 21/482; H04N 21/61

(52) U.S. Cl. CPC H04N 21/4825; H04N 21/6175

(57) ABSTRACT

The present invention relates to an internet multimedia system. The internet multimedia system includes a remote server comprising a backend application program, wherein the backend application program is built as a web-based platform, accessed by a browser and provides a program playlist comprising a plurality of arranged uniform resource locators; and a local device connected with the remote server through an internet and comprising a frontend application program and the browser for providing a user to operate the backend application program through the browser, wherein the frontend application program installs and executes on the local device and accesses the program playlist through the backend application program.

### FIELD

The present application claims the benefit of Taiwan Intellectual Property Office patent application no. 105122416 entitled as “Internet Multimedia System Based on Uniform Resource Locator and the Method for Establishing the same” filed on Jul. 15, 2016 in the Taiwan Intellectual Property Office, the disclosure of which is incorporated herein its entirety by reference.

The present invention relates to an internet multimedia system, in particular to an internet multimedia system built based on multiple uniform resource locators.

### BACKGROUND

The streaming media is video or audio content sent in compressed form over the internet and played immediately, rather than being saved to the hard drive, and the streaming media technology refers to a multimedia content that is constantly received by and presented to an end-user while being delivered by a provider. On the contrary to the conventional file downloading, a process in which the end-user obtains the entire file for the content before watching or listening to it.

The streaming technology can transmit a live audio and video in real time or a film preserved on an internet server. The streaming content containing audio and video data is being immediately played by a streaming player embedded in the internet browser or a specific player. That is, through the streaming media technology, a user can straightforwardly view a film embedded in a webpage through the internet connection, without downloading or saving it to the local-end device.

In recent years, due to the development of the multimedia technology, the streaming media technology becomes a very stable and well established technology. As long as a user stays at a venue with good internet connectivity, usually one can view a film embedded in the webpage through the internet connection, without downloading or saving it to the local-end device in advance.

The only thing a current modern user has to do for viewing a film on a certain webpage is to input a set of symbols representing for a uniform resource locator (URL) into the address bar on the browser. After linking to the webpage, a user can access the film on the webpage, play it by activating the streaming player and view it on the browser through the internet connection, as long as the quality of the internet connection is fast and good enough to receive the streaming multimedia content for the film. A uniform resource locator (URL) also known as a web address is a reference to a web resource that specifies its location on a computer network and a mechanism for retrieving it. A URL is a specific type of uniform resource identifier (URI), although many people use the two terms interchangeably.

For the sake of well established streaming media technology, there are full of various films and videos tubes over the internet, and people can view various films straightforwardly on the internet. The most popular and famous audio videos streaming platform is the YouTube platform. Anyone can feely upload, view and share the films on YouTube platform. There is a specific URL corresponding to a specific film on the YouTube platform.

Therefore, technically a user is not required to actually download or save the films on the YouTube platform to the local-end device. As long as a user keeps and has the corresponding URL and the internet connectivity is good and fast enough to stream and process the transmission for the film, one can view the film straightforwardly on the browser anytime anywhere by linking the a specific webpage containing the film through the URL address and using the streaming media technology.

Hence, it is possible and feasible to collect and organize multiple URLs and establish a playlist for the URLs to build an internet multimedia system for any user. There is also a need to provide the above internet multimedia system for any user and public.

### SUMMARY

The present invention provides an internet multimedia system for a user to edit and create a playlist consisting of multiple URLs (uniform resource locators). The internet multimedia system includes a remote server includes a backend application program, wherein the backend application program is built as a web-based platform, accessed by a browser and provides a program playlist including a plurality of arranged uniform resource locators; and a local device connected with the remote server through an internet and including a frontend application program and the browser for providing a user to operate the backend application program through the browser, wherein the frontend application program installs and executes on the local device and accesses the program playlist through the backend application program, wherein the backend application program opens the program playlist for the user to create and provides a form-based interface with multiple options for the user to operate to create a channel which is able to be viewed through the frontend application program, the backend application program offers a programming-free form-based operating environment on the browser for the user to create the program playlist by simply selecting the options on the form-based interface and without going through programming process, and the user can publish the channel to a public.

Preferably, the local device is one selected from a flat television, a set-top box, an over-the-top box, a smart phone, a tablet computer, a notebook computer, a laptop computer and a desktop computer.

Preferably, the internet includes one selected from a cloud internet, a local internet, a GSM network, a 3G network, a 4G network, a 5G network, a Wi-Fi network and a combination thereof.

Preferably, the backend application program is built as the web-based platform based upon a platform as a service (PaaS) technology and able to be accessed by the browser.

Preferably, the backend application program includes a channel management module, a subscriber management module and a personal data management module.

Preferably, the frontend application program includes a video streaming player, the frontend application program accesses a webpage containing a multimedia content through one of the plurality of the uniform resource locators provided by the backend application program, and the video streaming player plays the multimedia contents.

Preferably, the multimedia content is one selected from an audio content, a video content, and a voice content.

Preferably, the frontend application program includes a main operation interface and the main operation interface includes a main play area, a broadcast element, a module function button, a channel switch button and a program switch button.

Preferably, the frontend application program is able to dynamically call one of a real-time communication module, a smart home control module, and a cloud backpack.

### DESCRIPTION OF THE DRAWINGS

A more complete appreciation of the invention and many of the attendant advantages thereof are readily obtained as the same become better understood by reference to the following detailed description when considered in connection with the accompanying drawing, wherein:

FIG. 1 is a schematic diagram illustrating the architecture of the physical layer for the internet multimedia system in accordance with the present invention.

FIG. 2 is a schematic diagram illustrating the operation interface on the channel management module for the backend application program in accordance with the present invention.

FIG. 3 is a schematic diagram illustrating the channel management page for the option the Channel MGMT in the operation interface in accordance with the present invention.

FIG. 4 is a schematic diagram illustrating the channel addition page for the option the Channel MGMT in the operation interface in accordance with the present invention.

FIG. 5 is a schematic diagram illustrating the personal date maintenance page for the option the Personal Data in the operation interface in accordance with the present invention.

FIG. 6 is a schematic diagram illustrating the main play interface provided by the frontend application program in accordance with the present invention.

FIG. 7 is a schematic diagram illustrating the basic architecture concept for the frontend application program in accordance with the present invention.

FIG. 8 is a schematic diagram illustrating an operation interface for the smart home function module in accordance with the present invention.

FIG. 9 is a schematic diagram illustrating the operation interface for selecting a one-by-one chat in the present CmoreChat function module in accordance with the present invention.

FIG. 10 is a schematic diagram illustrating the operation interface for performing a selection of a contact person to chat in the present CmoreChat function module in accordance with the present invention.

FIG. 11 is a schematic diagram illustrating the operation interface for texting messages in the present CmoreChat function module in accordance with the present invention.

FIG. 12 is a schematic diagram illustrating the operation interface for selecting a group chat in the present CmoreChat function module in accordance with the present invention.

FIG. 13 is a schematic diagram illustrating the operation interface for creating a group chat in the present CmoreChat function module in accordance with the present invention.

FIG. 14 is a schematic diagram illustrating the operation interface for texting and sending a set of URL message in the present CmoreChat function module in accordance with the present invention.

FIG. 15 is a schematic diagram illustrating the operation interface for sending a message mixed with URLs and texts in the present CmoreChat function module in accordance with the present invention.

FIG. 16 is a schematic diagram illustrating the operation interface for processing the URL in the present CmoreChat function module in accordance with the present invention.

FIG. 17 is a schematic diagram illustrating the operation interface for classifying and organizing URLs while saving URLs into the CmoreBox in the present CmoreChat function module in accordance with the present invention.

FIG. 18 is a schematic diagram illustrating a hierarchical-based data management architecture adopted by the present CmoreBox backpack module.

FIG. 19 is a schematic diagram illustrating a front page interface for the CmoreBox backpack module in accordance with the present invention.

FIG. 20 is a schematic diagram illustrating an index page interface for the CmoreBox backpack module in accordance with the present invention.

FIG. 21 is a schematic diagram illustrating the operation interface for assigning the title for the first layer and the subtitle for the second layer during storing the URL hyperlink in the CmoreBox backpack module in accordance with the present invention.

FIG. 22 is a schematic diagram showing a webpage containing and playing a YouTube video film activated by a URL hyperlink after a user clicks the URL hyperlink in accordance with the present invention.

FIG. 23 is a schematic diagram illustrating a channel list page showing available channels provided by the frontend application program running on a mobile device in accordance with the present invention.

FIG. 24 is a schematic diagram illustrating the main play interface shown on a mobile device, according to FIG. 6 and provided by the frontend application program running on a mobile device in accordance with the present invention.

FIG. 25 is a schematic diagram illustrating the main play interface shown on a PC device, according to FIG. 6 and provided by the frontend application program running on a PC device in accordance with the present invention.

FIG. 26 is a schematic diagram illustrating the main play interface shown on a flat TV device, according to FIG. 6 and provided by the frontend application program running on a flat TV device in accordance with the present invention.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

It is to be noticed that the term “including”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

The personal computer described in the present disclosure is preferably, a desktop computer, a notebook computer or a tablet computer. The mobile device described in the present disclosure is preferably a smart phone, a tablet computer, a phablet (a.k.a. a tablet phone) or a wearable device. The internet described in the present disclosure is preferably a cable network, a wireless network, a cloud network, a local area network (LAN) or a wide area network (WAN), a GSM network, a 3G network, a 4G network or a Wi-Fi network. The application program described in the present disclosure is hereinafter referred to as App for short, which App is a program implementable and executable on the aforementioned mobile device. For the sake of describing the present invention simply and definitely, the aforementioned personal computer is to be exemplarily described with respect to but not limited to a desktop computer and the aforementioned mobile device is to be exemplarily described with respect to but not limited to a smart phone.

It is to be noticed that the present disclosure includes contents in Taiwan patent application number 100126878 entitled as “METHOD OF PROVIDING CONTENTS FOR MOBILE COMPUTING DEVICE” filed on Jul. 28, 2011, contents in Taiwan patent application number 101115678 entitled as “SYSTEM AND METHOD OF ESTABLISHING APPLICATION PROGRAM FOR MOBILE COMPUTING DEVICE” filed on May 2, 2012, contents in Taiwan patent application number 101123945 entitled as “ESTABLISHING SYSTEM AND METHOD FOR ESTABLISHING APPLICATION PROGRAM FOR MOBILE COMPUTING DEVICE AND HAVING CAPABILITY CONTROLLING INPUT AND OUTPUT INTERFACE” filed on Jul. 3, 2012, contents in Taiwan patent application number 102118126 entitled as “ESTABLISHING PLATFORM FOR IF-THIS-THAN-THAT RULE BASED APPLICATION PROGRAM USED IN MOBILE COMMUNICATION DEVICE” filed on May 22, 2013 and contents in Taiwan patent application number 104130848 entitled as “SYSTEM AND METHOD ESTABLISHING APPLICATION PROGRAM WITH DYNAMIC-LINK FUNCTION MODULE FOR MOBILE DEVICE” filed on Sep. 7, 2015, which above-identified applications have the Applicants the same as the present invention does and are incorporated into this application by reference as if fully set forth herein.

With the progress and development of multimedia and video streaming technology, nowadays it is full of a variety of audio and video films in different formats, such as avi, mkv, mov, mp4, DivX, Theora, MPEG-4, mpeg and wmv etc., all over the internet. Anyone can easily embed these films into a webpage, website, or upload these films to a video platform, to share them with friends or the public. Anyone who interests in these films can easily access to these films simply by inputting a set of a uniform resource locator (URL) at local browser's address bar. The URL is a combination of symbols, frequently referred to as a web address or a hyperlink, and points toward a specific webpage embedded with these films. Then the user can play and watch these films through the streaming player built in the local browser. As long as the quality of network connectivity is good enough, a user can straightforwardly watch these films on the browser through the internet.

Technically, users do not require actually downloading and saving these films to the local end device. As long as the user well keep and hold the corresponding URL, the user can access to the specific webpage and watch these films anytime anywhere, through the web browser and the internet, as long as the Internet connectivity is in a good condition.

However, it is possible to arrange, organize or group multiple URLs in accordance with the theme, the topic, or the attribution which the films embedded in the corresponding URL relate to, so as to form a set of URL playlist consisting of multiple URLs. Then the URL playlist can be regarded as a multimedia channel and multiple channels can be built accordingly. Therefore, each channel has its own URL playlists. Then the technology the Platform as a Service (PaaS) is applied to store the URL playlist on an internet server at a remote end. Anyone can easily watch the film through linking to the specific webpage specified by the URL containing the film by using the internet browser.

That is the present invention provides a internet multimedia system (hereinafter termed as CmoreTV). By colleting a large number of URLs, after screening, arranging, organizing and classifying the URLs to form multiple channels. Each channel includes a set of URL playlist consisting of multiple URLs. Through the PaaS technology, it allows users to watch the films on-demand anytime anywhere. The sequences of multiple channels can follow the current sequences of channels in cable TV, when compiling the sequences of multiple channels, so as to form an internet television similar to the current cable TV. Even the formed internet television uses the channelized concept.

For example, there are two well-known channels on the cable TV. The channel 18 is the National Geographic channel, and the channel 19 is the Discovery channel. Therefore, the channels 18 and 19 in the CmoreTV system can be correspondingly left or build for the National Geographic channel and Discovery channel. It is only required to aggregate, edit and arrange multiple URLs directing and linking to the webpages containing officially released films from the National Geographic channel and the Discovery channel respectively, to compose two URL playlists respectively. Then the two URL playlists are uploaded to the channel 18 and channel 19 respectively on the CmoreTV system, to correspondingly and similarly form the National Geographic channel and the Discovery channel in the CmoreTV system.

Similarly, the 58th channel on the cable TV system currently is the Unique Financial channel. The channel 58 in the CmoreTV system is arranged to correspondingly provide the URL playlist consisting of URLs linking to the webpages including the real-time financial news films released from the Unique Financial channel. Therefore, an internet TV multimedia which is like the current cable TV system is formed accordingly.

In addition to build the sequence of channels in the CmoreTV system in reference with the current sequence of channels in the cable TV system, the system administrator can create and prepare more available blank channels and release the blank channels for the channel manager. The channel manager can compile the URL playlist on one's own will for one's own channel. Alternatively, the channel manager can make one's own multimedia contents, such as, to film the self-media contents or a live webcast contents, and then provide the URL linking to the webpage containing the self-media contents for this one's own channel, to form a personalized channel.

The authority to access the playlists on different channels can be setup by the system administrator. For example, the playlists in the channels 0˜99 are corresponding to the channels in the Cable TV system, and therefore the channels 0˜99 are opened available for publics. Anyone can access the playlist and watch the multimedia contents provided on channels 0˜99. However, channels 200˜300 can be setup as the subscription-required channel, the paid channel or the free subscription-required channel. Certainly the system administrator can lease or rent the available blank channels to people who are interesting in running the channel, to further form a business model.

Under the concept of the CmoreTV system, the total number of channels has no limitations. The channels can have many kinds of usages as well, for example, available for the government organizations as the channel to broadcast and announce the government decrees and policies, available for the charity as the channel to raise fund, available for the celebrities or public icon as the channel to show and enhance personal image, available for the internet celebrity as the channel to play a live webcast, and etc. The contents provided by the CmoreTV system is not limited to the non-real time media content, and can be a live media content, a synchronous media content, a non-synchronous media content, a playback content, a live streaming content, a professionally-generated content (PGC), an occupationally-generated content (OGC), a user-generated content (UGC), a self media content, a we media content, and so on.

Typically the present invention proposes and builds a multimedia network big system (CmoreTV), covering a physical layer and an application program layer, the application program layer includes a frontend broadcasting desk application program and a backend control and management desk application program. The big system combines the clouding computing technologies, including the software as a service (SaaS) technology, and the platform as a service (PaaS) technology, to create a big multimedia network system capable of providing multimedia contents for any user.

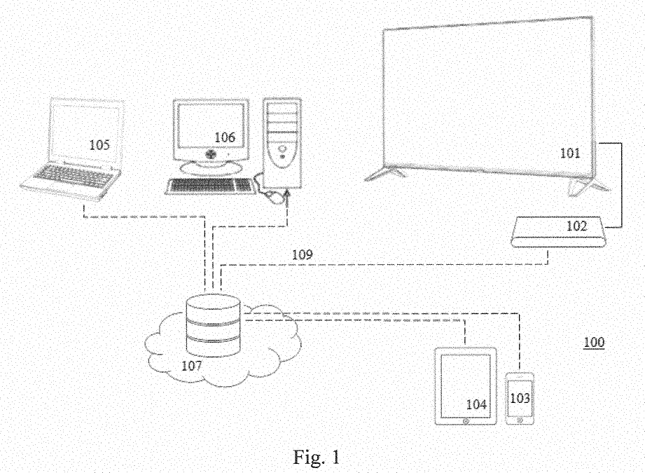

FIG. 1 is a schematic diagram illustrating the architecture of the physical layer for the internet multimedia system in accordance with the present invention. The physical layer 100 in FIG. 1 includes a flat TV 101, an over-the-top (OTT) box 102, a smart phone 103, a tablet computer 104, a notebook computer 105, and a desktop computer 106 at a local end and an internet server 107 at a remote end. The OTT box 102, the smart phone 103, the tablet computer 104, the notebook computer 105, and the desktop computer 106 at the local end are linked to the internet server 107 at the remote end by the internet 109, so as to exchange data with each other. The internet 109 consists of one selected from a cloud internet, a local network, a wide area network, a GSM network, a 3G network, a 4G network, a Wi-Fi network and combinations thereof. The OTT box 102 is preferably the Android OS over-the-top box (referred to as OTT box for short).

In the ecosystem of the CmoreTV system in accordance with the present invention, a variety of roles of persons get involved in as follows:

(1) System administrator: the person creates and builds the CmoreTV system and is responsible for providing, maintaining, updating and managing the frontend application program and the backend application program, providing the internet server at the remote end for users to use.

(2) Channel manager: the person is also known as the station director, who is responsible for organizing, editing and scheduling the URL playlist to form a specific channel One channel manager probably handles or runs one or multiple channels. The channel manager can upload the accomplished URL playlist to the backend application program through a channel management module on the backend application program. Then anyone can watch the films on the webpage the URL directs toward through the frontend application program.

The channel manager is preferably a management staff hired by the system administrator who is responsible for establishing the contents in channels, a government unit that intends to use a specific channel, a business company that wants to book a specific channel to sale the product or broadcast the advertisements, an internet blog celebrity, a super movie star, an internet celebrity who wants to build one's own personal channel dedicated for fans. A membership system can be applied to the CmoreTV system.

(3) Ordinary user: the person refers to the numerous general consumers or the subscribers who are the main target the CmoreTV system serves. An ordinary user downloads and installs the frontend application program (termed as the CmoreTV App) from the Android Google Play to the OTT box 102, the smart phone 103, the tablet computer 104, the notebook computer 105 or the desktop computer 106. Then the ordinary user activates the CmoreTV App and watches the multimedia contents on various channels by running the CmoreTV App.

The backend application program in the application program layer is installed on the internet server 107 at the remote end. The PaaS technology is applied to the backend application program, so that the backend application program is demonstrated as a web-based platform. Anyone with proper permission can access to the backend application program anytime anywhere through the browser to operate the backend application program. The backend application program is built and developed by a system provider or the system administrator. The backend application program provides different levels of access permissions for different levels of personals. The backend application program includes a channel management module and a user can easily create a URL playlist through the channel management module by operating the browser.

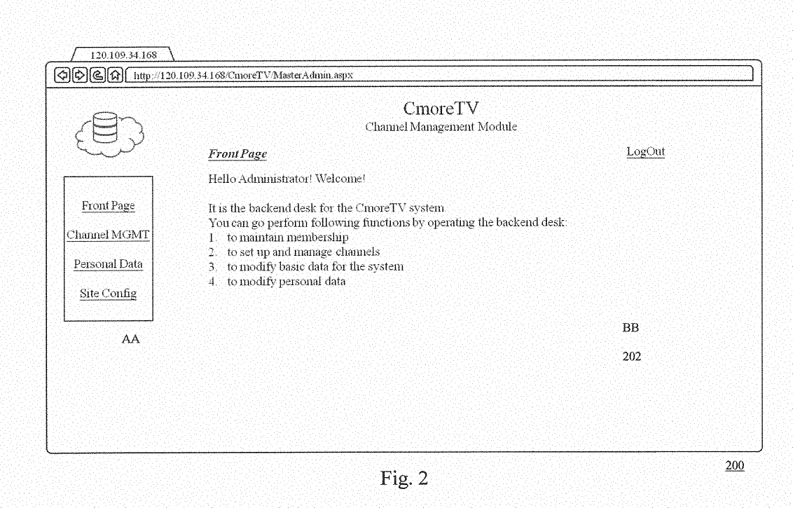

FIG. 2 is a schematic diagram illustrating the operation interface on the channel management module for the backend application program in accordance with the present invention. The PaaS technology is applied to the backend application program in the present invention, so as to show and provide the backend application program for the users in a format of a web site and the backend application program in the present invention is basically a web-based platform. A user can easily access and operate the backend application program by operating the browser at local end. The operation interface 200 in FIG. 2 on the channel management module for the backend application program includes the option area AA and the operation area BB. The option area AA includes the options the Front Page, the Channel MGMT (channel management), the Personal Data and the Site Config (site configuration). When a user clicks and enters the option the Front Page in the option area AA, the welcome page 202 shows in the operation area BB on the operation interface 200. The welcome page 202 contains simple operation description about how to get started to operate and use the channel management module.

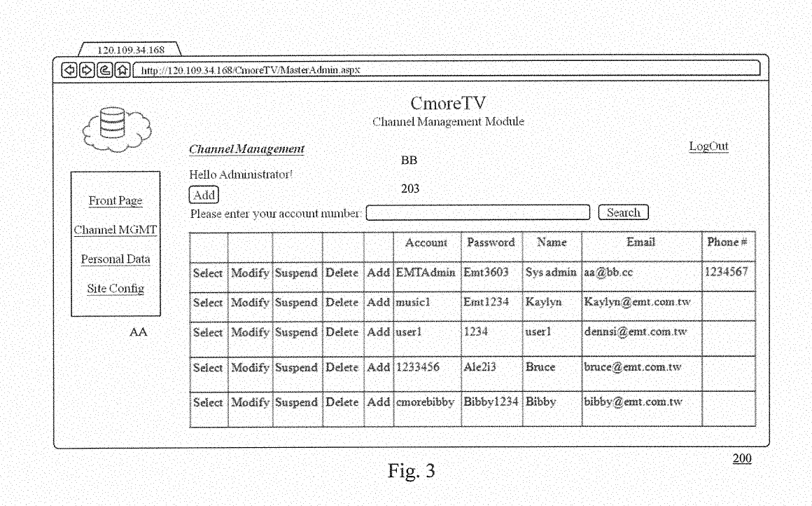

FIG. 3 is a schematic diagram illustrating the channel management page for the option the Channel MGMT in the operation interface in accordance with the present invention. When a user clicks and enters the option the Channel MGMT in the option area AA, the channel management page 203 shows in the operation area BB on the operation interface 200. The design for the channel management page 203 is mainly made as a simple table and user-friendly and human-centered, to make the channel management page 203 easy to operate for users. A user can simply add, delete the member, change the membership rights, or assign a new channel for a specific member by simply operating the channel management page 203.

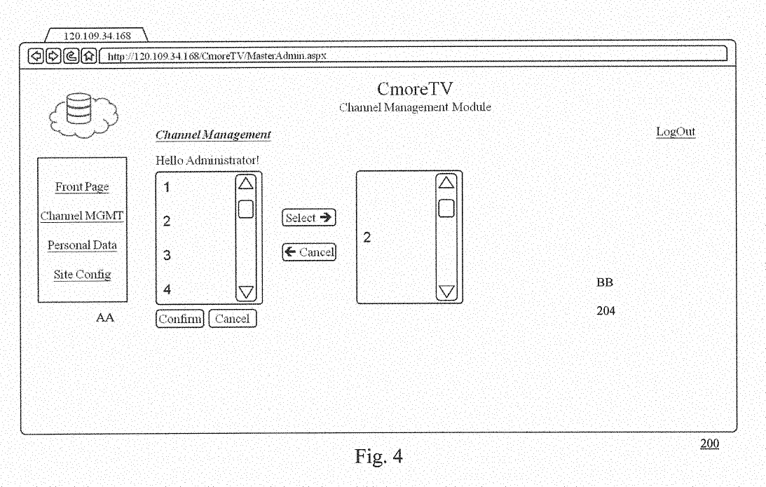

FIG. 4 is a schematic diagram illustrating the channel addition page for the option the Channel MGMT in the operation interface in accordance with the present invention. When a user clicks the Add button in the table on the channel management page 203, the channel addition page 204 shows in the operation area BB on the operation interface 200. Two simple checkboxes shown in the channel addition page 204 are provided for users to add or cancel/delete channels. When the user finishes the modifications for channels, press the Confirm button. The modifications for channels are saved and preserved in the system.

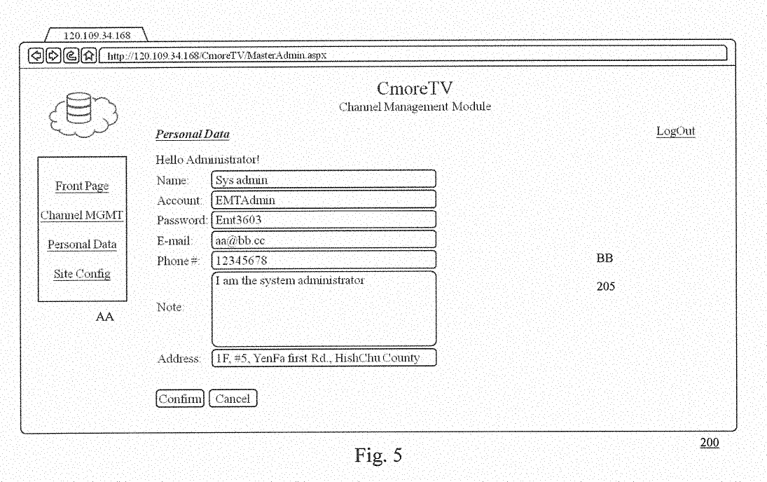

FIG. 5 is a schematic diagram illustrating the personal date maintenance page for the option the Personal Data in the operation interface in accordance with the present invention. When a user clicks the option the Personal Data in the option area AA, the personal data maintenance page 205 shows in operation area BB on the operation interface 200 in FIG. 5. The design for the personal data maintenance page 205 is user-friendly and human-centered as well as the channel management page 203. A user can easily create, modify a personal data profile that contains name, account, password, E-mail, phone number, address, notes, etc. When the user finishes the modifications for personal data, press the Confirm button. The modifications for personal data are saved and preserved in the system.

The frontend application program acts as a streaming play platform and is made as an application program capable of running on any Android mobile device. In this embodiment, the frontend application program is made as an .apk file in Android format. The frontend application program is uploaded to the Android Google Play market and available for the public. After download, the frontend application program is installed onto the OTT box 102, the smart phone 103, the tablet computer 104, the notebook computer 105 or the desktop computer 106. A streaming player is built in the frontend application program and a player interface is provided for users. After the frontend application program receives the URL playlist from the backend application program, it links to the specific webpage directed by the URL on the designated time according to the URL playlist, accesses the film on the specific webpage, and commands the streaming player to broadcast the film on the webpage for users.

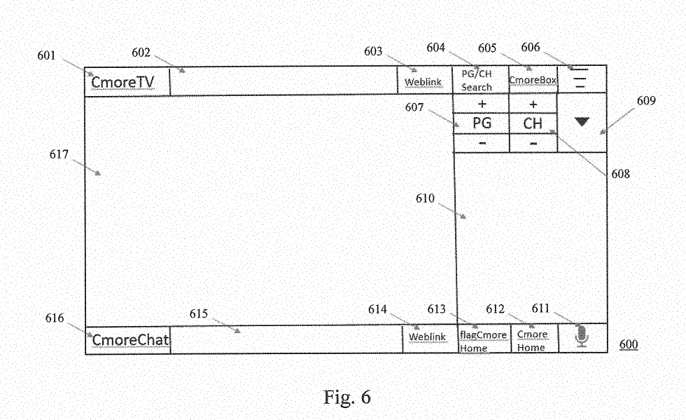

FIG. 6 is a schematic diagram illustrating the main play interface provided by the frontend application program in accordance with the present invention. The main play interface 600 in FIG. 6 includes a playing area 617 and multiple function elements distributed around the playing area 617. The function elements include program ID field 601, upper broadcast bar 602, upper linkage area 603, channel search bar 604, my backpack button (CmoreBox) 605, info bulletin 606, film switch area 607, channel switch area 608, hidden buttons area 609, the relevant films area 610, voice search button 611, smart home button (CmoreHome) 612, CmoreHome message return area 613, lower linkage area 614, lower broadcast bar 615, and instant message button (CmoreChat) 616. The location for the above multiple function elements are not limited to scatter around the playing area 617 and can be arranged arbitrarily. The numbers of the above multiple function elements are not limited and can be added and deleted arbitrarily. The dimension for the above respective multiple function elements are not limited and can be magnified or minimized arbitrarily. In this embodiment, the .apk file for the frontend application program is installed on the user's smart phone.

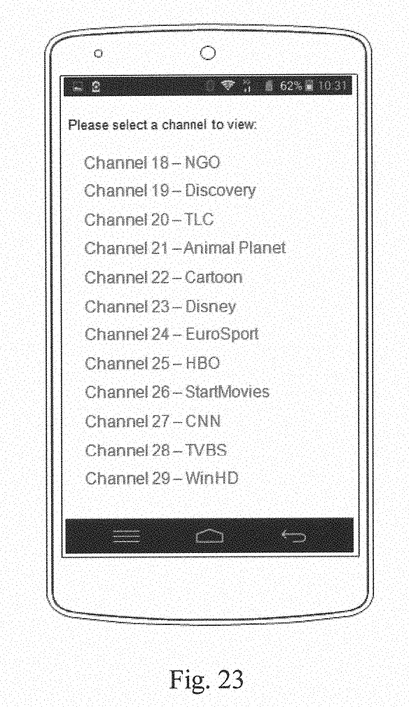

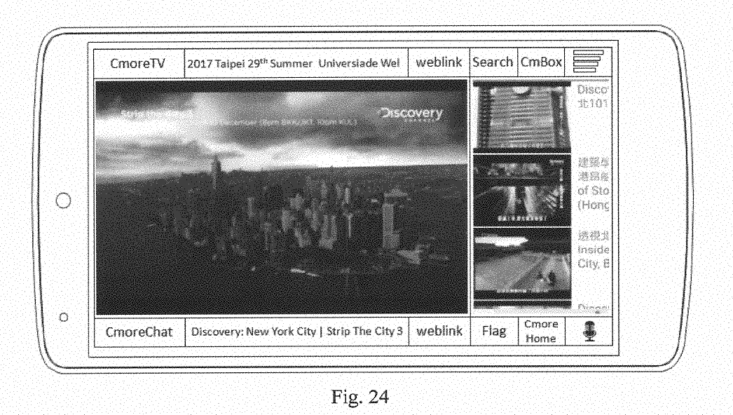

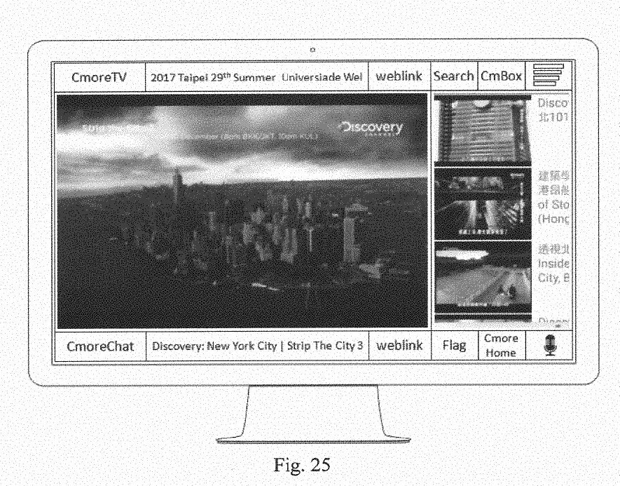

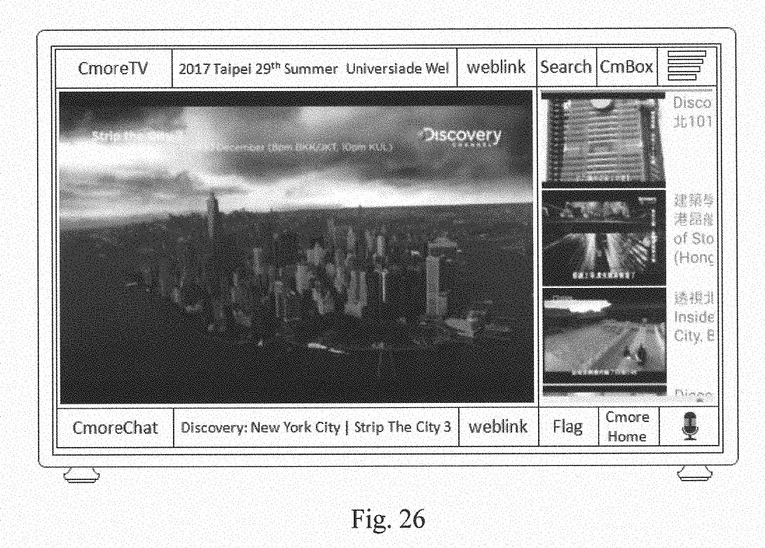

FIG. 23 is a schematic diagram illustrating a channel list page showing available channels provided by the frontend application program miming on a mobile device in accordance with the present invention. FIG. 24 is a schematic diagram illustrating the main play interface shown on a mobile device, according to FIG. 6 and provided by the frontend application program running on a mobile device in accordance with the present invention. FIG. 25 is a schematic diagram illustrating the main play interface shown on a PC device, according to FIG. 6 and provided by the frontend application program mining on a PC device in accordance with the present invention. FIG. 26 is a schematic diagram illustrating the main play interface shown on a flat TV device, according to FIG. 6 and provided by the frontend application program running on a flat TV device in accordance with the present invention.

When a user opens the App of the frontend application program on a mobile device, for example, a channel list showing all available channels is first shown as shown in FIG. 23. If a user selects and enters the 19th channel (channel 19) which is the discovery channel, one enters a main play interface 600 as shown in FIG. 6. As shown in FIGS. 24 to 26 the main play interface program starts playing the selected film provided by the selected channel. In main play interface 600, around the playing area 617 there are multiple function elements provided for a user to operate. There are multiple films related to the selected film playing in the playing area 617 shown in the relevant films area 610. When a user selects and determines to play and watch a certain film in the playing area 617, the system automatically selects multiple films related to the selected film playing in the playing area 617 according to the theme, the topic, or the attribution of the selected films, and then recommends and shows the relevant films in the relevant films area 610 for users to select and to watch.

The program ID field 601 is used for showing the trademark and the name of this application program. The upper broadcast bar 602 and the lower broadcast bar 615 are also known as the electronic scroll billboard and used for showing various messages, covering the title of the currently playing film, the advertisements, the announcements, or the notifications etc. For example, during the first three seconds the user initially gets started to watch the film, the upper broadcast bar 602 is used for showing the title of the film being watched, and after first three seconds, the upper broadcast bar 602 is used for showing the advertisements from sponsors.

The contents shown in the upper broadcast bar 602 can includes a set of URL hyperlink. When a user clicks the URL hyperlink shown in the upper broadcast bar 602, a specific webpage, a landing page or an advertisement page is popped up. The user can review the webpage and even go further to purchase and buy something on this webpage. Also the system administrator can develop a charging mechanism to provide the upper broadcast bar 602 and the lower broadcast bar 615 available for partners, sponsors, or advertisers to use, which is able to increase the additional value, the commercial value and the commercial result or to create a new business model for the present internet multimedia system. For example, the power of usage to the upper broadcast bar 602 authorizes to the system administrator only to broadcast the contents pertaining to the official announcements or notifications, but the power of usage to the lower broadcast bar 615 leases out to other sponsors to broadcast the advertisements. It is worth to notice the backend application program has the function to edit and manage the contents or the texts shown in the upper broadcast bar 602 and the lower broadcast bar 615.

The upper linage area 603 and the lower linkage area 614 are embedded with a set of URL hyperlink which is associated or not associated with the film being watched. When a user clicks the URL hyperlinks shown in the upper linage area 603 or the lower linkage area 614, one can reach the specific webpage designated in the URL hyperlinks. The channel search bar 604 allows a user to input a set of keywords to search for channels associated with the keywords. The voice search button 611 allows a user to speak a set of keywords to search for associated channels by voice. After a user pushes the voice search button 611, one can speak out a set of keyword for system to recognize. The system activates and performs a keyword search to find out the associated channels. The info bulletin 606 is reserved for the system administrator to use to display the official notifications or announcements.

If a user intends to switch among films in the channel, one can press buttons in the film switch area 607. If the “+” button is pressed, the film being watched in the main playing area 617 is switched to a film sorted before the current film. If the “−” button is pressed, the film being watched in the main playing area 617 is switched to a film sorted after the current film. If a user intends to switch to different channel, one can press buttons in the channel switch area 608. If the “+” button is pressed, the system loads a channel sorted before the current channel, and the film playing in the main playing area 617 and the relevant films showing in the relevant films area 610 are correspondingly changed to those in the loaded channel. If the “−” button is pressed, the system loads a channel sorted after the current channel, and the film playing in the main playing area 617 and the relevant films showing in the relevant films area 610 are correspondingly changed as well.

The hidden button area 609 collects and hides more functional buttons which are not frequently used by a user, and not so important and secondary for a user. For example, a button to add new channels is arranged to reserve in the hidden button area 609. The buttons in the film switch area 607, the channel switch area 608 and the hidden button area 609 are the hidden buttons. In general operation, a user can not view the buttons in these areas 607, 608 and 609. When a user moves a cursor to move into the film switch area 607, or when a user makes a drag gesture or moves fingers inside these areas 607, 608 and 609, the channel switch area 608 and the hidden button area 609, buttons hidden in these areas 607, 608 and 609 go appear for user to select and click.

The smart home button (CmoreHome) 612 is a button linking to a smart home function module. The smart home function module is built in the internet multimedia system the CmoreTV or made as a subroutine or an external application program. In this embodiment, the smart home function module is made as an external application program which is an Android based application program (App) and installed on the OTT box. When a user presses the smart home button 612, one activates the Android App, a smart home appliances controller App.

The smart home function module regards the OTT box as a central intelligent console platform for remotely controlling various home appliances so as to establish a smart home environment. Through various telecommunication protocols, such as, Wi-Fi or Bluetooth, equipped and the Android App installed on the OTT box, the smart home function module installed on the OTT box is able to wirelessly connected with and control the home appliances, such as, the while home appliances, the electronic products, wearable devices, the health care devices and or other devices pertaining to the internet of things (IoT), to achieve the smart home control or the health care for the elderly.

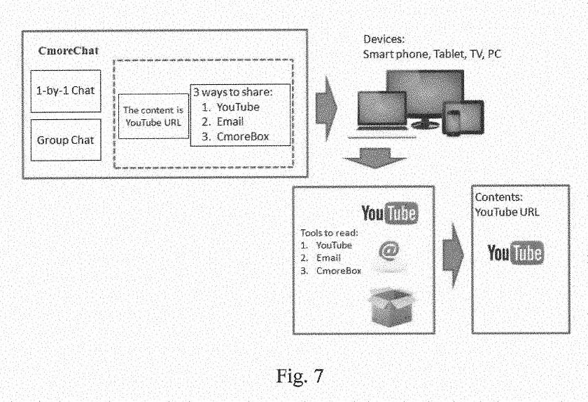

FIG. 7 is a schematic diagram illustrating the basic architecture concept for the frontend application program in accordance with the present invention. Basically the frontend application program is able to run on a mobile device, a PC device, a tablet device, a flat TV device, or a smart phone device. The main content the frontend application program provides is the YouTube URL. That is through the leading by the CmoreTV platform on the OTT box, a TV handheld remote controller becomes and acts as a central console to realize a smart home environment. While a user is viewing TV through the internet multimedia system the CmoreTV, one can operate and control the home appliances by activating the smart home function module by pressing the smart home button (CmoreHome) 612, simply through operating the conventional remote controller held in hand.

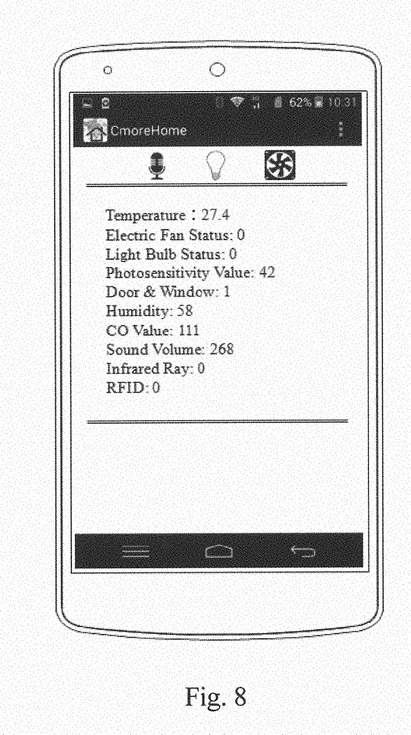

FIG. 8 is a schematic diagram illustrating an operation interface for the smart home function module in accordance with the present invention. The smart home realized through the CmoreTV is about to have a scenario as described as follows. After the CmoreHome App is executed on the OTT box, for example, a user can control home appliances, such as, a micro phone, a light bulb, an electric fan, a washing machine, a refrigerator, a lamp, a television, an air conditioner . . . and more home appliances, by using the remote controller in the living room when viewing CmoreTV. The CmoreHome App provides a voice command mode. As long as the remote controller has equipped with a mini microphone, a user can control the home appliances by human voice as well. While the voice command mode is activated, a user can speak out the input keyword to the microphone to input voice command.

Furthermore, the CmoreHome App can read the data detected by the sensors disposed on the home appliances, such as the temperature, the humidity, the concentration value for carbon monoxide, the radio signal from RFID, and etc. While CmoreHome App reads an anomaly data or a data exceed a specific threshold, the App sends a message back to the CmoreHome message return area 613 to report back the anomaly condition to a user. For example, if the window is detected to be opened abnormally, a notification message is sent back to the CmoreHome message return area 613 by the CmoreHome App. A user clicks the notification message, reads it and knows the window is opened abnormally. The CmoreHome App can work with the IFTTT module to produce a synergy effect among devices. For example, while the temperature above 28° C. (Celsius) is detected, the IFTTT module automatically turns on an air conditioner, to build a very smart and comfortable home.

The instant message button (CmoreChat) 616 is connected to instant message/instant chat function module. The CmoreChat module function module is built in the internet multimedia system the CmoreTV or made as a subroutine or an external application program. In this embodiment, the smart home function module is made as an external application program which is an Android based application program (App) and installed on the OTT box. When a user presses the instant message button 616, one activates the Android App, an instant message social communication App.

Nowadays, there is a variety of instant message software everywhere, such as, Line, WeChat, WhatsApp, Skype and so on, and each instant message software is independent and has one's own fans. However, the APIs (Application Programming Interface) of these respective instant message software are somehow not well designed, and do not provide enough functions. The most importance is these APIs cannot support and apply to the present internet multimedia system the CmoreTV. Therefore, a dedicated instant message function module referred to as CmoreChat is developed and established and dedicated to work with the present internet multimedia system the CmoreTV.

The main goal to add the CmoreChat the instant message function module in the CmoreTV platform is to render the audio and video entertainment services provided on the CmoreTV platform to instantly share with friends, publics and social community, through the CmoreChat the instant messages function module. So the information sharing and exchanging on the CmoreTV platform becomes so convenience and friendly and the CmoreTV platform therefore provides and have the instant messages (IM) function and the social networking system (SNS) function.

Basically, the sharing between communities and people should try to break out from the distance, try to go across devices and try to transcend the age gaps. The present system tries to transfer the information flow from a personal device to the living room, the living center of each family, and then shift from one's living room to another one's living room, and to make the sharing among people transform to the sharing among family staffs, and tries to bring the system into the living room, the living center of each family.

The present CmoreChat module the instant message function module allows a user to login or register by email or telephone number. The CmoreChat instant message function module has and performs functions as follows:

(1) The one by one chat function: a user can select a single specific contact person from the established contact list to perform a one-by-one message texting or voice communications. A set of URL information can be straightforwardly included in the texting message, for opening a YouTube video, an Email. One can save the URL information into the CmoreBox.

(2) The communication or chat among social communities (group chat): creating a group, and then select and bring multiple contact persons together into the group to chat or send text message. A set of URL information can be straightforwardly included in the texting message, for opening a YouTube video, an Email. One can save the URL information into the CmoreBox.

(3) The CmoreChat can be performed on various mobile devices, smart phones, tablet computers, OTT boxes, smart TVs, notebook computers, laptop computers, and desktop computers, to provide chat and communications among users.

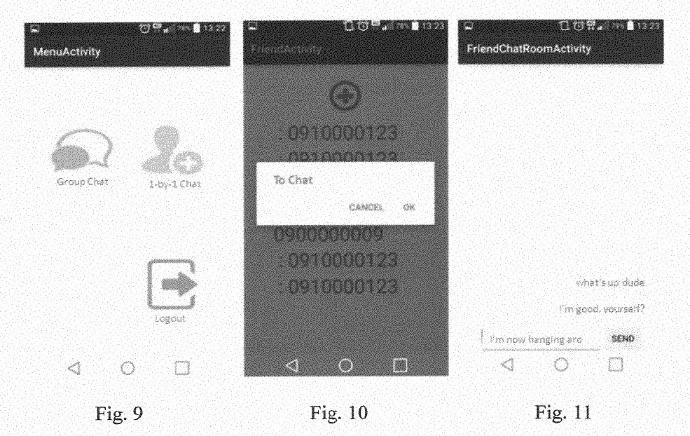

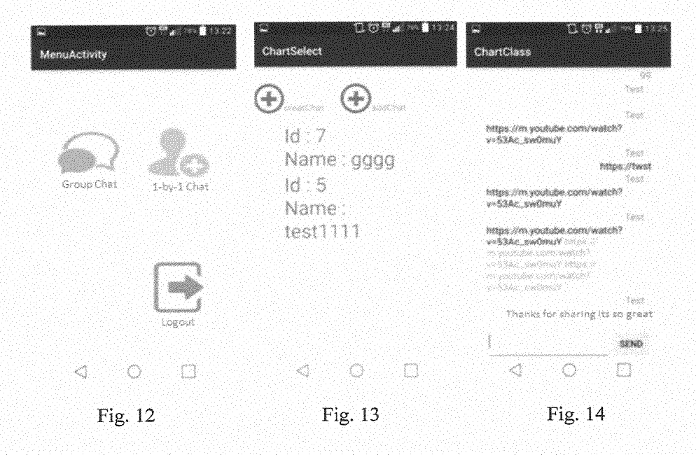

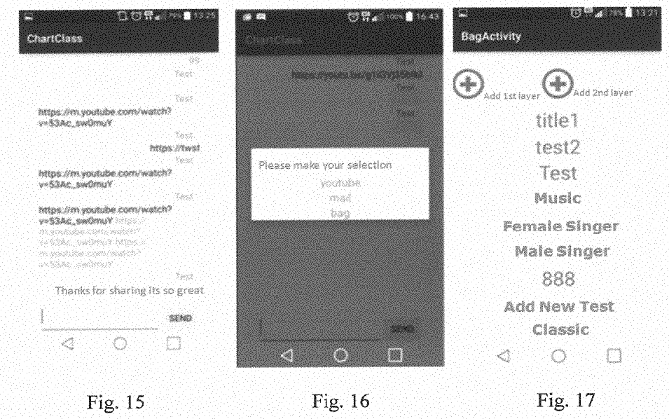

FIG. 9 is a schematic diagram illustrating the operation interface for selecting a one-by-one chat in the present CmoreChat function module in accordance with the present invention. FIG. 10 is a schematic diagram illustrating the operation interface for performing a selection of a contact person to chat in the present CmoreChat function module in accordance with the present invention. FIG. 11 is a schematic diagram illustrating the operation interface for texting messages in the present CmoreChat function module in accordance with the present invention. FIG. 12 is a schematic diagram illustrating the operation interface for selecting a group chat in the present CmoreChat function module in accordance with the present invention. FIG. 13 is a schematic diagram illustrating the operation interface for creating a group chat in the present CmoreChat function module in accordance with the present invention. FIG. 14 is a schematic diagram illustrating the operation interface for texting and sending a set of URL message in the present CmoreChat function module in accordance with the present invention. FIG. 15 is a schematic diagram illustrating the operation interface for sending a message mixed with URLs and texts in the present CmoreChat function module in accordance with the present invention. FIG. 16 is a schematic diagram illustrating the operation interface for processing the URL in the present CmoreChat function module in accordance with the present invention. FIG. 17 is a schematic diagram illustrating the operation interface for classifying and organizing URLs while saving URLs into the CmoreBox in the present CmoreChat function module in accordance with the present invention.

Through the sharing function brought by the CmoreChat module the instant message module, a user can save the favorite, lovely, touched, meaningful or memorable contents anytime anywhere. At this moment, a personalized cloud storage space the CmoreBox backpack module has served an important function.

The my backpack button (CmoreBox) 605 is connected to the CmoreBox backpack module, a personalized cloud storage space. The CmoreBox backpack module is built in the internet multimedia system the CmoreTV or made as a subroutine or an external application program. In this embodiment, the CmoreBox backpack module is made as an external application program which is an Android based application program (App) and installed on the OTT box. When a user presses the my backpack button (CmoreBox) 605, one activates the Android App, which is mainly responsible for providing a structuralized file folder on a cloud server for recording, storing and managing data and files, and has a nickname referred to as cloud backpack.

In addition to effectively storing the URL hyperlinks and recording data shared in the CmoreChat module, the CmoreBox backpack module provides a file management function which allows a user to specify and customize a title for each data and to classify data by one's own. Since these entertainment video contents are all sourced from the URL hyperlinks, it is only required for a user to click the customized title to play the video contents on the mobile device or on smart TV, and the user is not required to actually provide a digital space to substantively save the digital files for these entertainment video contents. When a user clicks the customized title, one can also share the corresponding URL to the CmoreChat function module.

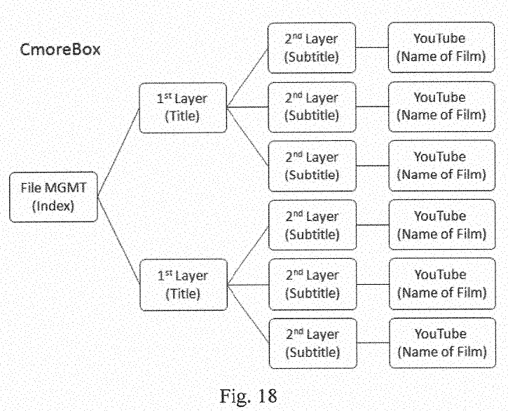

FIG. 18 is a schematic diagram illustrating a hierarchical-based data management architecture adopted by the present CmoreBox backpack module. At least two layers or more layers of data structures are adopted as the file management architecture for the present CmoreBox backpack module. The title for the first layer and the subtitle for the second layer are all allowed for a user to define. Each layer is able to contain unlimited numbers of multiple folds. Typically the CmoreBox account name and the CmoreChat account name are same or interlocked, and each CmoreTV account has assigned with its own personal cloud backpack the CmoreBox backpack module.

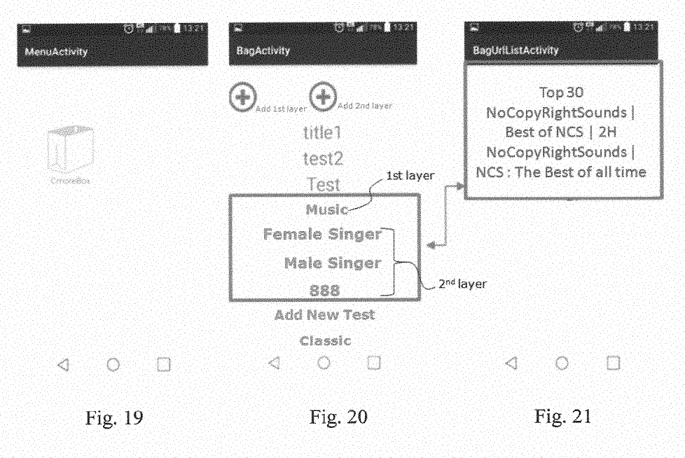

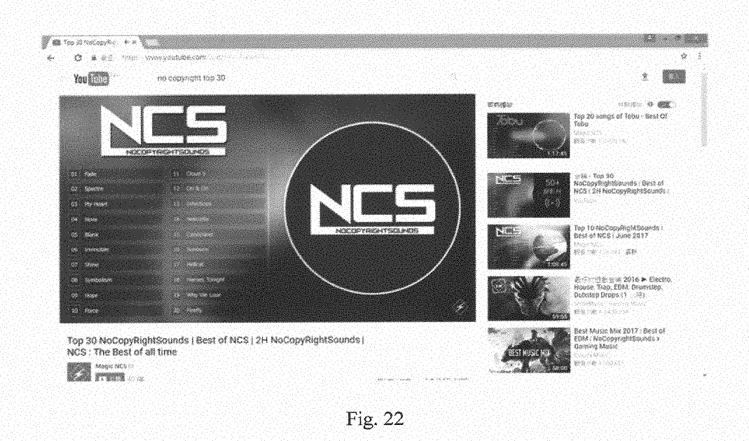

FIG. 19 is a schematic diagram illustrating a front page interface for the CmoreBox backpack module in accordance with the present invention. FIG. 20 is a schematic diagram illustrating an index page interface for the CmoreBox backpack module in accordance with the present invention. FIG. 21 is a schematic diagram illustrating the operation interface for assigning the title for the first layer and the subtitle for the second layer during storing the URL hyperlink in the CmoreBox backpack module in accordance with the present invention. FIG. 22 is a schematic diagram showing a webpage containing and playing a YouTube video film activated by a URL hyperlink after a user clicks the URL hyperlink in accordance with the present invention.

The internet multimedia system provided by the present invention integrates different types of internet multimedia and is unprecedented. The present system has never been seen before in the domain of smart home applicant in the field of Internet of Things (IoTs) or Internet of Beings (IoBs). The present system combines various functions to integrate and blend the cloud technology, the PaaS service technology, the IFTTT service, various sensors, all kinds of sensors, the OTT box, the flat TV all together, to build up a big multimedia system. The present system emphasizes on the daily life applications and brings users unprecedented convenience with extremely rich user experiences.

In particular, the present invention utilizes the Android based OTT box, to bring the entire internet multimedia system into the living room, the living center of each family. Uses the TV device in the living room as a control center and a route, to diffuse into a user's personal daily life and to make wireless connection with and access to the white appliances, the electronic appliances, the home appliances, the wearable devices, the care-take devices, the health care devices, various sensors, various transceivers, various devices in the IoT or IoB, to achieve a smart home control and realize a smart home environment. It also brings and diffuses the business mode into the living room by the present internet multimedia system.

Furthermore, because the present internet multimedia system is designed based on the concept and architecture of IoT, the applications thereof are extremely flexible, varied and full of possibility. The control center is able to switch from the TV device to the mobile phone. Uses the mobile device as a control center and a route, to diffuse into a user's personal daily life and to access the wearable devices, the care-take devices, the health care devices, various sensors, and various transceivers around the user, and to achieve a smart control and to realize a smart lifestyle for a user.

Moreover, because the frontend application program responsible for playing the streaming packages is the application program (App), in the aspect of practical applications, it is easy and feasible to bring in and combine lot of commercial operations. For example, the system administrator can even invite well-known bloggers, internet celebrities, movie stars and other celebrities to establish and set up an exclusive personal channel, an image channel on the CmoreTV system.

There are further embodiments provided as follows.

Embodiment 1: An internet multimedia system includes a remote server including a backend application program, wherein the backend application program is built as a web-based platform, accessed by a browser and provides a program playlist including a plurality of arranged uniform resource locators; and a local device connected with the remote server through an internet and including a frontend application program and the browser for providing a user to operate the backend application program through the browser, wherein the frontend application program installs and executes on the local device and accesses the program playlist through the backend application program, wherein the backend application program opens the program playlist for the user to create and provides a form-based interface with multiple options for the user to operate to create a channel which is able to be viewed through the frontend application program, the backend application program offers a programming-free form-based operating environment on the browser for the user to create the program playlist by simply selecting the options on the form-based interface and without going through programming process, and the user can publish the channel to a public.

Embodiment 2: The internet multimedia system as described in Embodiment 1, the local device is one selected from a flat television, a set-top box, an over-the-top box, a smart phone, a tablet computer, a notebook computer, a laptop computer and a desktop computer.

Embodiment 3: The internet multimedia system as described in Embodiment 1, the internet includes one selected from a cloud internet, a local internet, a GSM network, a 3G network, a 4G network, a 5G network, a Wi-Fi network and a combination thereof.

Embodiment 4: The internet multimedia system as described in Embodiment 1, the backend application program is built as the web-based platform based upon a platform as a service (PaaS) technology and able to be accessed by the browser.

Embodiment 5: The internet multimedia system as described in Embodiment 1, the backend application program includes a channel management module, a subscriber management module and a personal data management module.

Embodiment 6: The internet multimedia system as described in Embodiment 1, the frontend application program includes a video streaming player, the frontend application program accesses a webpage containing a multimedia content through one of the plurality of the uniform resource locators provided by the backend application program, and the video streaming player plays the multimedia contents.

Embodiment 7: The internet multimedia system as described in Embodiment 6, the multimedia content is one selected from an audio content, a video content, and a voice content.

Embodiment 8: The internet multimedia system as described in Embodiment 1, the frontend application program includes a main operation interface and the main operation interface includes a main play area, a broadcast element, a module function button, a channel switch button and a program switch button.

Embodiment 9: The internet multimedia system as described in Embodiment 1, the frontend application program is able to dynamically call one of a real-time communication module, a smart home control module, and a cloud backpack.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. An internet multimedia system, comprising:
a remote server comprising a backend application program, wherein the backend application program is built as a web-based platform, accessed by a browser and provides a program playlist comprising a plurality of arranged uniform resource locators; and
a local device connected with the remote server through an internet and comprising a frontend application program and the browser for providing a user to operate the backend application program through the browser, wherein the frontend application program installs and executes on the local device and accesses the program playlist through the backend application program,
wherein the backend application program opens the program playlist for the user to create and provides a form-based interface with multiple options for the user to operate to create a channel which is able to be viewed through the frontend application program, the backend application program offers a programming-free form-based operating environment on the browser for the user to create the program playlist by simply selecting the options on the form-based interface and without going through programming process, and the user can publish the channel to a public.

2. The internet multimedia system as claimed in claim 1, wherein the local device is one selected from a flat television, a set-top box, an over-the-top box, a smart phone, a tablet computer, a notebook computer, a laptop computer and a desktop computer.

3. The internet multimedia system as claimed in claim 1, wherein the internet comprises one selected from a cloud internet, a local internet, a GSM network, a 3G network, a 4G network, a 5G network, a Wi-Fi network and a combination thereof.

4. The internet multimedia system as claimed in claim 1, wherein the backend application program is built as the web-based platform based upon a platform as a service (PaaS) technology and able to be accessed by the browser.

5. The internet multimedia system as claimed in claim 1, wherein the backend application program comprises a channel management module, a subscriber management module and a personal data management module.

6. The internet multimedia system as claimed in claim 1, wherein the frontend application program comprises a video streaming player, the frontend application program accesses a webpage containing a multimedia content through one of the plurality of the uniform resource locators provided by the backend application program, and the video streaming player plays the multimedia contents.

7. The internet multimedia system as claimed in claim 6, wherein the multimedia content is one selected from an audio content, a video content, and a voice content.

8. The internet multimedia system as claimed in claim 1, wherein the frontend application program comprises a main operation interface and the main operation interface comprises a main play area, a broadcast element, a module function button, a channel switch button and a program switch button.

9. The internet multimedia system as claimed in claim 1, wherein the frontend application program is able to dynamically call one of a real-time communication module, a smart home control module, and a cloud backpack.
